(19) United States
(12) Patent Application Publication
(10) Pub. No.: US 2026/0215630 A1
(43) Pub. Date: Jul. 30, 2026

(54) COMPACT ZERO-MICRO GRAVITY SPACE TOILET WITH VACUUM-PACK DISPOSAL

(71) Applicant: CHIN SEONG LIM, Pinang (MY)

(72) Inventor: CHIN SEONG LIM, Pinang (MY)

(21) Appl. No.: 19/270,619

(22) Filed: Jul. 16, 2025

(30) Foreign Application Priority Data
Jan. 24, 2025 (MY) PI2025000664

(51) Int. Cl. A47K 11/02; B64G 1/60

(52) U.S. Cl. CPC A47K 11/02; B64G 1/60

(57) ABSTRACT

The present application relates to a toilet system (100) for a zero-gravity or microgravity environment, comprising: a toilet seat (101) having an opening therethrough for a user to seat; a refuse pack (102) having a rim (107) on top side with at least one opening, and a plastic sheet (108) with a bottom plate (106) for forming a compartment at bottom; at least one air blower (103) to direct at least one human waste or any solids to the refuse pack (102) from the opening using a flow of air; a sealed chamber (104) having a Hatch door (105), positioned below the toilet seat (101) to accommodate the refuse pack (102), characterized in that the bottom plate (106) having at least one fastening means to secure the Refuse pack (102) to the toilet system (100) or chamber (104); at least one Flapper valve (111) connected to a vacuum pump system to pull the air from the compartment; and at least one top plate for securing on the rim (107) to seal the Refuse pack (102), in such way that the vacuum pump system pumps out the remaining the air in compartment of the sealed Refuse pack (102) for storage and containment.

### FIELD OF INVENTION

This invention pertains to a toilet system for human waste or human excreta collection with features which allow it to be used in zero-gravity environment.

### BACKGROUND OF THE INVENTION

Waste collection, management, and disposal usually pose serious health concerns onboard current spacecraft, making more difficult by weightlessness and the lack of substantial power and water supplies. Having to handle human feces in a way that is against their culture and experience may also have an emotional impact on the crew and passengers, particularly on inexperienced passengers.

The first inflight solid waste collection system was an adhesive-rimmed bag that was placed on the subject's buttocks and had a finger cot built in for removing adhering material, which has significant operational challenges.

After that, Skylab employed a seat with a flow-through air entrapment system, an integrated filter, and a separate, changeable bag collector. Following vacuum drying, each bag was preserved for eventual return to Earth. A more effective system is needed for the space shuttle due to the Skylab waste collection system's size, complexity, and power expense. This system used a single large pot with a centrifugal macerator/slinger which would plaster the pot walls with successive layers of fecal material, which were subsequently dried by vacuum. There are serious operational difficulties with this system.

An example of a waste collection system can be found in U.S. Pat. No. 9,694,920B2 which discloses a toilet used in outer space gathering system in accordance with a preferred embodiment of the present invention comprises: a guiding cylinder, a speed decreasing machine, a speed decreasing machine, a control panel, a switch, and a power source, wherein the guiding cylinder includes an inlet member and an outlet member disposed thereon, includes a spiral peg placed therein.

There have been several innovations in the field of trash collection and storage, but none that effectively and easily address the issues encountered during space travel have been created yet. The combination of air flow means, vacuum means, replaceable pads, and a storage means has never been found in a device that is small, easy to use, and effective.

### SUMMARY OF THE PRESENT INVENTION

One embodiment of present invention features a toilet system for a zero-gravity or microgravity environment, comprising: a toilet seat having an opening therethrough for a user to seat; a refuse pack having a rim on top side with at least one opening, and a plastic sheet with a bottom plate for forming a compartment at bottom; at least one air blower to direct at least one human waste or any solids to the refuse pack from the opening using a flow of air; a sealed chamber having a Hatch Door, positioned below the toilet seat to accommodate the refuse pack, characterized in that the bottom plate having at least one fastening means to secure the Refuse Pack to the toilet system or chamber; at least one Flapper valve connected to a vacuum pump system to pull the air from the compartment; and at least one top plate for securing on the rim to seal the Refuse Pack, in such way that the vacuum pump system pumps out the remaining air in compartment of the sealed Refuse Pack for storage and containment.

Further, the toilet system comprising at least one auxiliary blower to blow air from one side of the toilet seat to route of the air into the refuse pack.

Further, the refuse pack comprising at least one mesh means to block the human waste or the solids return to the opening or outside of the Refuse Pack.

Preferably, the refuse pack further comprising at least one super absorbent polymer (SAP) layer.

Preferably, the SAP layer attached to the plastic sheet, such that the air that passes through the refuse pack pass through the SAP layer.

Preferably, the sap layer is air permeable sheet.

Further, the toilet system toilet system comprising at least one activated charcoal pack to filter-out odour from the air exiting of the vacuum pump or the toilet system.

Preferably, the top plate having a layer of UV Activated Adhesive or Pressure Sensitive Adhesive for securing onto the rim of the refuse pack to seal the compartment.

Further, the toilet system comprising at least one roller plate on the chamber for sliding with a sliding means to slide out to release the rim of the refuse pack positioned on the chamber.

Further, the toilet system comprising at least one vomit attachment having a mouth piece to mount a user mouth, a flexible hose to direct at least one liquid waste from the user, and a vomit attachment for forming a seal around the toilet seat.

Preferably, the toilet seat shaped in such way that the user's buttocks form at least one closure around sides of the toilet seat and form a gap at the user's crotch area to receive air.

Preferably, the sealed Refuse Pack is positioned in the chamber for the user to dispose.

Preferably, the Hatch Door having seal to secure is closed to seal the chamber and opened to access the chamber.

Another embodiment of present invention features a portable toilet system (100) for use in an automobile, boat, airplane or other vehicle, comprising: a toilet seat having an opening therethrough for a user to seat; a refuse pack having a rim on top side with at least one opening, and a plastic sheet with a bottom plate for forming a compartment at bottom; at least one air blower to direct at least one human waste or any solids to the refuse pack from the opening using a flow of air; a sealed chamber having a Hatch Door, positioned below the toilet seat to accommodate the refuse pack, characterized in that the bottom plate having at least one fastening means to secure the Refuse Pack to the toilet system or chamber; at least one Flapper valve connected to a vacuum pump system to pull the air from the compartment; and at least one top plate for securing on the rim to seal the Refuse Pack, in such way that the vacuum pump system pumps out the remaining air in compartment of the sealed Refuse Pack for storage and containment.

The present invention consists of features and a combination of parts hereinafter fully described and illustrated in the accompanying drawings, it being understood that various changes in the details may be made without departing from the scope of the invention or sacrificing any of the advantages of the present invention.

### BRIEF DESCRIPTION OF THE DRAWINGS

To further clarify various aspects of some embodiments of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the accompanying drawings in which:

FIG. 1 illustrates front view of an embodiment of a Toilet Bowl.

FIG. 2 illustrates rear view of the Toilet Bowl.

FIG. 3 illustrates an embodiment a Refuse Pack.

FIG. 4 illustrates one embodiment of movement or flow air in Refuse Pack in the Toilet Bowl.

FIG. 5 is an illustration one embodiment of Vacuum Pump with activated charcoal pack outlet attached to the Toilet Chassis or Refuse Pack.

FIG. 6 illustrates the Toilet Bowl with Cover Sheet on the Refuse Pack's Rim and Roller plate slide-out.

FIG. 7 illustrates the Toilet Bowl with compact and sealed Refuse Pack.

### DETAILED DESCRIPTION OF THE INVENTION

The present invention relates to a toilet system that can used to collect human waste in a zero-gravity environment.

The main concepts of the current design are that at least one waste is stored in vacuum-pack disposal system or disposable Refuse Pack. Wherein during use in Microgravity or zero-gravity environment, air flow from at least two blowers directs Stool, urine, menses or vomit to at least one air permeable layer containing Super Absorbent Polymer (SAP). On the other hand, on, during use on Moon, the stool and urine falls directly onto the layer containing SAP. The Refuse Pack is sealed and vacuum packed after use for containment.

### Disposable Refuse Pack

It Functions as the “Toilet Bowl” during operation. The disposable nature of the Pack ensures zero clean up required between use as the entire “Toilet Bowl” is renewed.

Holds feces/urine/menses/vomit/wipes inside and acts as a storage bag for disposal. The Disposable Refuse Pack designed to be vacuum packed to contain the waste.

Toilet Bowl or Toilet Chassis comprising a toilet seat with an auxiliary Blowers, a Refuse Pack placed below a Toilet Seat, and Vacuum Pump with activated charcoal pack outlet to direct the air out from the Toilet Chassis or Refuse Pack.

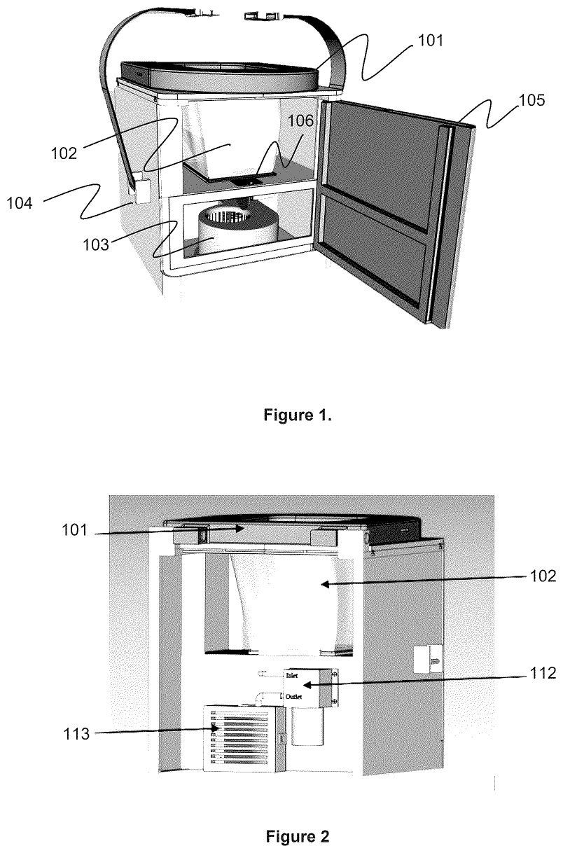

FIG. 1 illustrates the front view of the Toilet Bowl when the Hatch Door is open, the bottom chamber is sealed. Once the Main Blower operates, air is pulled in through the Refuse Pack.

FIG. 2 illustrates the rear view of the Toilet Bowl. The Vacuum Pump is connected to the one-way valve on the Refuse Pack via a stainless-steel pipe. The connection between the Refuse Pack and Vacuum Pump is vital to vacuum the Refuse Pack for storage and containment.

As illustrated in FIG. 1 and FIG. 2, illustrates one embodiment of a Toilet Bowl or toilet system (100) preferably for a micro or zero-gravity environment.

The toilet system (100) comprising of a toilet seat (101) having an opening therethrough for a user to seat; a refuse pack (102) having a Rim (107) on top side with at least one opening, and a Plastic Sheet (108) with a bottom plate (106) for forming a compartment at bottom; at least one air blower (103) to direct at least one human waste or any solids to the refuse pack (102) from the opening using movement or flow of air; a sealed chamber (104) having a Hatch door (105), positioned below the toilet seat (101) to accommodate the refuse pack (102).

The toilet system (100) further comprising at least one fastening means at the bottom plate (106) to secure the Refuse pack (102) to the toilet system (100) or chamber (104).

The bottom plate (106) also has at least one Flapper Valve (111) connected to a vacuum pump (112) system to pull the air from the compartment; in such way that the vacuum pump (112) pumps out the air in compartment of the sealed Refuse pack (102) from the toilet seat (101).

The toilet seat (101) preferably has at least one auxiliary blower (103) to blow air from one side of the toilet seat (101) to route of the air-flow into the refuse pack (102).

The Hatch door (105) having seal to secure is closed to seal the chamber (104) and opened to access the chamber (104).

The toilet system (100) further comprising at least one activated charcoal pack (113) to filter-out odour from the air-flow exiting of the vacuum pump (112) or the toilet system (100).

The vacuum pump (112) system connected to at least one Flapper Valve (111) on the bottom plate (106) to pull the air-flow from the compartment; in such way that the vacuum pump (112) pumps out the air in compartment of the sealed Refuse pack (102) from the toilet seat (101).

The toilet system (100) comprising at least one activated charcoal pack (113) to filter-out odour from the air exiting of the vacuum pump (112) or the toilet system (100).

The toilet seat (101) shaped in such way that the user's buttocks form at least one closure around sides of the toilet seat (101) and form a gap at the user's crotch area to receive air.

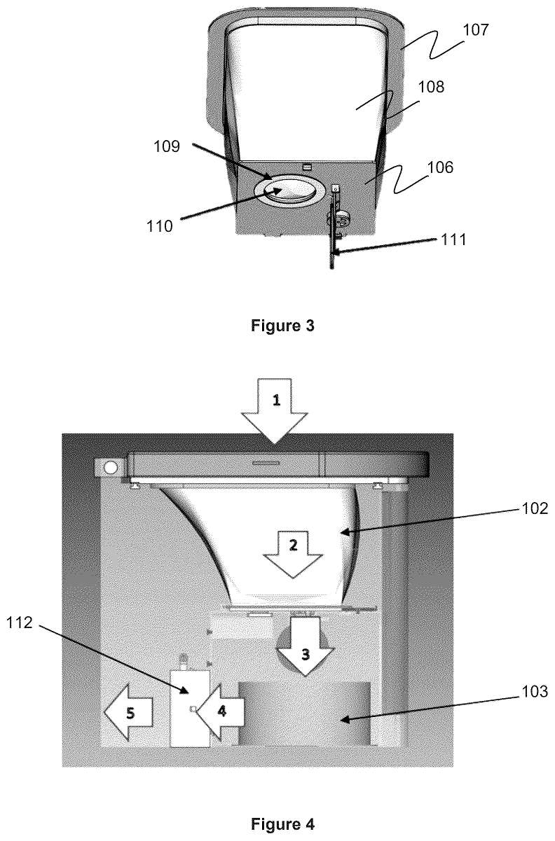

As illustrated in FIG. 3, the Refuse pack (102) comprising of a Rim (107), Plastic Sheet (108) and a Bottom plate (106) attached together. The bottom plate (106) having at least one fastening means to secure the Refuse pack (102) to the Toilet Chassis. The fastening means is Notch or Latch to fasten the Refuse pack (102) to the Toilet Chassis. Preferably, the Plastic Sheet (108) and SAP Layer are flexible, such that the Refuse pack (102) can be collapsed for storage.

The Bottom plate (106) having at least one spring loaded Flapper Valve (111) with a one-way valve (110) and a sealant (109) to form a one-way opening. The Spring-Loaded Flapper Valve (111) allows air to pass through the Refuse pack (102) when it's in open state. The one-way valve (110) allows the Refuse pack (102) to be vacuumed once the Rim (107) is covered and Flapper Valve (111) is closed state. The one-way valve also allows left over air and vapor pressure inside the pack to escape the pack once the pack is left on the moon's surface, where it is exposed to high vacuum of space, preventing it from ballooning and/or burst.

The SAP layer is like an adult diaper without the impermeable plastic backing. This makes it air permeable in the design.

The side of the SAP layer is attached to the Flexible Plastic Sheet (108), such that all air that passes through the Refuse pack (102) have to pass through the SAP layer.

The Pressure Sensitive Adhesive (PSA) layer allows the flapper to be glued or fastened shut permanently once the Refuse pack (102) is vacuum packed for containment and safe disposal. During storage, the PSA layer is protected by a protective layer that is to be peeled away before use.

The toilet system (100) comprising at least one Refuse pack (102). Preferably, the refuse pack (102) further comprising at least one Super Absorbent Polymer (SAP) layer. The SAP layer attached to the Plastic Sheet (108), such that the movement or flow of air that passes through the refuse pack (102) pass through the SAP layer. the SAP layer is Air Permeable sheet.

Further, the refuse pack (102) comprising at least one mesh or net means to block the human waste or the solids return to the opening or outside of the Refuse pack (102).

The mesh or net allows air to pass, but will capture dry stool, preventing it from moving up again in zero or Micro-G environment. The SAP layer may come with a net to capture dried stool that does not stick to the SAP layer. The Refuse pack (102) is positioned manually in the chamber (104) when the user needs to use. The Disposable Refuse pack (102) designed to be vacuum packed to contain the waste.

The Refuse pack (102) comprising of a Rim (107), Plastic Sheet (108) and a Bottom plate (106) attached together. The bottom plate (106) having at least one fastening means to secure the Refuse pack (102) to the Toilet Chassis. The fastening means is Notch or Latch to fasten the Refuse pack (102) to the Toilet Chassis. Preferably, the Plastic Sheet (108) and SAP Layer are flexible, such that the Refuse pack (102) can be collapsed for storage.

FIG. 4 illustrates one embodiment of movement or flow of air in Refuse pack (102) in the Toilet Bowl, preferably at Microgravity or zero-gravity environment.

### Microgravity

The air will flow through the Toilet seat (101) and Refuse pack (102) when the Main Blower (103) is running and Hatch is closed. In zero-gravity environment, both the Main and Aux Blower (103) will be switched on based on at least one sensor. This air movement or flow is vital for the Toilet to work in microgravity or zero-gravity environment.

### Air-Flow Through the Toilet

When at least one user sits on the Toilet seat (101), the user's buttocks form a seal around the sides of the seat except crotch area of the user using the toilet, such that all the air that flows through the blower (103) now enters via a small gap at the crotch area.

One embodiment of Flow Path of Air of the Toilet Bowl;
I. Air enters the Refuse pack (102) via the Crotch Area of user;
II. Air passes through the SAP layer;
III. Air exits the Refuse pack (102) through the Port at the Bottom plate (106);
IV. Air enters the Main Blower (103) and exits the main blower (103); and
V. Air that exits the blower (103) is passed through an activated carbon pack to remove odour. Odour free air exits the toilet.

From fluid mechanics and modelling via Computational Fluid Dynamics (CFD), the flow paths in the Refuse pack (102) will be as described above. Stool will be deposited via centre opening of toilet seat (101) and urine will be deposited near crotch area of user located front opening of toilet seat (101).

In microgravity or zero-gravity environment, stool will be pushed by the stream of air from the Auxiliary blower (103) located lower back of toilet seat (101) or lower-back of the user siting on the toilet seat (101), to join the main flow path of air above the Refuse pack (102), which the air enters via the crotch area of the user. Urine and menses will be deposited near the crotch area of user. This is directly in the flow path of air entering front part of the Refuse pack (102).

The flow now carrying stool, urine and menses will then pass through the layer containing SAP material. Loose stool, urine and menses will be absorbed. Sticky stool will stick to the surface of the layer containing SAP material.

However dry stool might re-join the vortex at back part of the Refuse pack (102), this is solved by adding a net on at the back part of the Refuse pack (102). The Net allows air to pass via back part of the Refuse pack (102), but will capture dry stool, preventing it from moving up again in microgravity or zero-gravity environment.

### Lunar Gravity

On the Moon, the gravity is ⅙ of Earth. This means stool, urine, menses and vomit will fall down by itself to the SAP layer. There is no need to switch on the Main and Auxiliary Blower (103). The Toilet will be used like a toilet on Earth. The Refuse pack (102) will function like in microgravity or zero-gravity environment, capturing fecal matter, urine, menses and vomit.

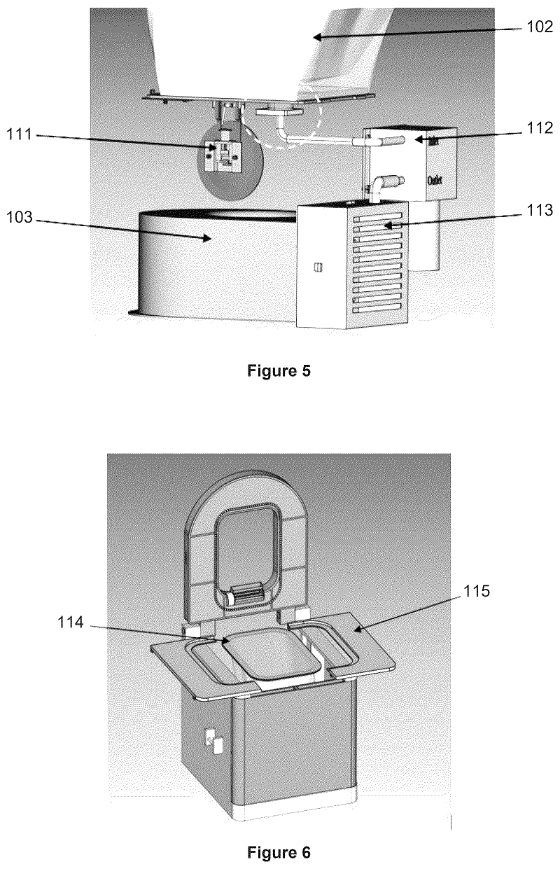

As illustrated in FIG. 5, one embodiment of a toilet system (100) comprising Vacuum pump (112) with activated charcoal pack (113) outlet attached to the Toilet Chassis or Refuse pack (102). The air that exits the Main Blower (103) and vacuum pump (112) is routes the air through an Activated Carbon Pack. This removes odor during use. Once vacuum packed, the odor inside the Refuse pack (102) is contained and do not escape into the Lander.

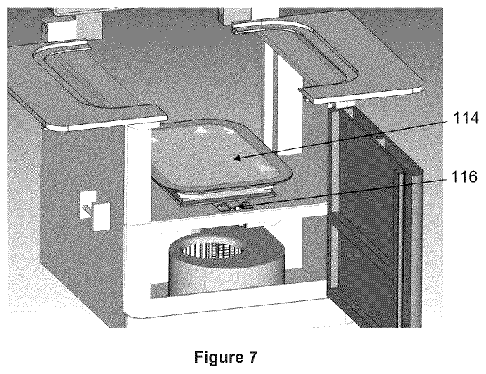

As illustrated in FIG. 6 and FIG. 7, the toilet system (100) comprising at least one roller plate (115) on the chamber (104) for sliding with a sliding means to slide out to release the rim of the refuse pack (102) positioned on the chamber (104). The User lifts Toilet Seat (101) and slides Roller plate (115) outward.

Preferably, the toilet system (100) further comprising at least one top plate (114) for securing on the Rim (107) to seal the Refuse pack (102), in such way that the vacuum pump (112) pumps out the remaining air in compartment of the sealed Refuse pack (102) for storage and containment.

The Refuse pack (102) is compact and sealed with a top plate (114) as illustrated in FIG. 7. Preferably, the top plate (114) having a layer of UV Activated Adhesive or Pressure Sensitive Adhesive for securing onto the Rim (107) of the refuse pack (102) to seal the compartment.

Preferably, the sealed Refuse pack (102) is positioned in the chamber (104) for the user to dispose.

### Male and Female Crew

There is no difference in the location where stool is deposited between male and female. So, system can accommodate male and female crew for No.2. For No.1, the user has to urinate sitting down. So, for female, it is not a problem. Male user will have to do a “sit down wee”.

### Ease of Use, Low Noise, Low Odor, Turnaround Time

The system will capture waste in Microgravity or zero-gravity and on the Moon, and the Refuse Pack is Vacuumed for storage and containment of waste.

Steps of how the refuse pack is vacuumed for storage and containment of waste;
I. Once user made his/her deposit, all wipes are thrown into the Refuse Pack.
II. User lifts Toilet Seat up and places a Cover Sheet on the Refuse Pack's Rim.
III. User closes the Toilet Seat. (The Bottom of the Toilet Seat has a strip of UV LEDs. Once closed, the UV LEDs will sit just above the cover sheet)
IV. User presses a button to turn on the LEDs. (This activates the UV Activated Adhesive to stick the Cover Sheet to the Rim of the Refuse Pack. After 30 sec, the LEDs will turn off and the toilet will beep. At this stage, the top of Refuse Pack is Sealed).
V. User lifts Toilet Seat and slides Roller plates outward. (Main Blower is running. Air is being evacuated from Refuse Pack).
VI. Once the Main Blower's current consumption reaches a point, the Toilet's system controller releases the Solenoid Latch holding the Flapper open. The Spring closes the Flapper Valve. The Main Blower shuts off. The Scroll Vacuum pump is powered up to vacuum the remaining air in the Refuse Pack. The force acting on the Flapper when the pack is being vacuumed pushes it hard against the PSA layer, permanently gluing it shut.
VII. User Opens the Hatch Door. Pulls on the latch holding the Refuse Pack to release the now vacuumed Refuse Pack.
VIII. User puts a New Refuse Pack in, latch the Flapper to the Solenoid Latch, lifts the Rim up and closes the Roller plate.
IX. The Toilet is now ready for the next user.

The entire process is expected to take 5 minutes. It's therefore quite easy to use. There are centrifugal blowers and scroll vacuum pumps available in the market at the sizes used in this design with brush-less motors that make less than 60 dB. The Blowers are inside the toilet which further attenuates the noise generated. The air that exits the Main Blower and vacuum pump is routes the air through an Activated Carbon Pack. This removes odor during use. Once vacuum packed, the odor inside the Refuse Pack is contained and do not escape into the Lander.

Preferably, the edges of the Cover Sheet are coated with UV Activated Adhesive. This is already complete on Earth during production and requires no action from the user beyond peeling off protective layer. If there is concern on UV, Pressure Sensitive Adhesive similar to the adhesive on Duct Tape but higher grade can also be used.

### Transfer of Collected Waste to Storage or External Vehicle Disposal

The vacuumed Refuse Pack can be moved outside the lander for storage and disposal once there is an opportunity (e.g.: During Scheduled Moonwalk). There is a one-way valve for excess air inside the Pack to vent to space.

### Additional Feature: Vomit Module

Additional embodiment of the system includes puke or barf module. The vomit module comprising at least one clips attach or fastening means to attached onto the Toilet Seat and forms a seal around Seat's opening. When Main Blower is running, air is forced to enter through of a mouth piece of the vomit module.

User puts his/her mouth at the mouth piece and vomits. Movement of air will suck the vomit into the Refuse Pack and absorbed into the SAP layer. This way, the user does not have to put his/her mouth into the Toilet.

The vomit module also able to capture and contain at least one liquid waste such as Urine, Feces, Vomit, Diarrhoea, Menses

The toilet uses at least two-pronged strategy to capture and contain the liquid waste.

Firstly, all waste is stored in the Refuse Pack. The Refuse pack has a layer containing Super Absorbent Polymer such as Sodium Polyacrylate or any other approved. SAP can be found as the water absorbing component in adult diapers and can absorb 100-1000 times its own mass in water. In the attached documents, a test was carried out on 25 grams of SAP and it was able to absorb 600 g of water. With that, 100 g of SAP is planned initially for the SAP Layer of each Refuse Pack.

The Toilet is designed in such a way that all biological waste that enters the Toilet, passes through this SAP layer.

The SAP layer is similar in construction to an adult diaper. The main difference is adult diaper has a water proof polymer backing while in this design, the SAP layer is open at the bottom to allow air to move pass it. Liquid waste moving through it will be absorbed by the Super Absorbent Polymer in it. Solid stool, will be trapped on top of it, similar to how an adult diaper capture stool. Thickness of the SAP layer will be adjusted during prototyping stage.

This use of SAP layer to capture urine has at least one benefit. The Refuse Pack does not need to be changed if it is only urine, especially when it is only 1-2 rounds of urine. At least one indicator can be placed to show or indicate the user if the Pack can still absorb water. If yes, it's suggested that the Refuse Pack does not need to be changed.

Only when at least one fullness indicator shows full, or it was used to capture fecal matter and/or vomit that it needs to be changed out

Secondly, once the vacuum packing of the Refuse Pack is done. All Refuse Pack, before change will need to be vacuum packed as outlined in the procedures in the previous section. This keeps the captured waste inside it, containing it, preventing spills and odour from escaping.

### Stabilize Urine

Urine, once absorbed by the SAP layer, will effectively be stabilized as the urine will be contained within the interior of the Polymer Network. Other approved stabilizing agents can be added in the SAP layer during manufacturing.

### Simultaneous Urination and Defecation

The movement or flow of air will capture both urine and stool at the same time and bring them to the SAP layer, in which urine will be absorbed by the Super Absorbent Polymer and stool will be trapped above the layer. In the event of recirculation, the SAP layer comes with a net to capture dried stool that does not stick to the SAP layer.

Stool is deposited at centre opening of toilet seat. Urine at near the crotch area of user. The air-flow will bring both to the SAP layer simultaneously. Position of Net to prevent dry stool from moving back up in Microgravity or zero-gravity.

### Usage of Refuse Pack

Each Refuse Pack can absorb a minimum of 1 liter of urine. From initial test, 100 g of SAP material planned can absorb 2.4 liters. So as far as urination is concerned, there is no need to Vacuum Pack and Change the Refuse Pack if it is only Urine unless it is full. If it is stool, then it needs to be changed. Thus, if the calculation goes by 14 days×2 packs/day×2 crew=56 Refuse Packs to be carried for the mission.

Each Refuse Pack is about 300 grams and can be collapsed flat for storage.

While that might sound like additional weight to carry, kindly note the following.

This design is completely isolated from space. Thus, there is no need for high grade pipes and valves to connect the toilet to space which carries its own weight penalty, not to mention additional risk of having another “hole” in the Lander.

Space connected toilets will likely use up some air during each “flush”. So, more air needs to be carried up there.

Depending on requirements, the used Refuse Pack can be left on the moon when the Lander leaves. There are design elements that ensures the pack does not burst when exposed to the high vacuum of space. This lightens up the Lander when it is time to leave.

So, depending on above, this design could come out ahead in terms of total weight and mission fuel requirements.

### Toilet Hygiene Products

The disposal of anti-bacterial wipes, tissue papers etc. into the Refuse Pack is possible. If it is in Zero-gravity, ensure the Main Blower is operating to ensure it is held onto the SAP Layer until the Cover Sheet is placed on.

### Clears Previous User's Waste

For urination, if the SAP layer is not full, it is suggested that it does not need to be changed. If the user defecates, then the user will need to replace with a new Refuse Pack. Once this happens, all waste from previous user will be cleared for the next user.

### Replacing Collection System

Collection System is also known as Refuse Pack, needs to be replaced whenever the user defecates or vomit into it. If it is just urine, then as long as the SAP layer is not full, it can be left in place and reused by the next user.

However, there is always a trade-off between small packs that are easy to replace but needs to be replaced more often vs larger tanks that can take more waste but harder to manage and replace. Its known fact that, the waste stored in a tank in the Space Station can burp or gases try to escape from storage. This sends odor throughout the entire space station. In the present design, the person making the deposit change out his own Refuse Pack, and clearing up own waste is certainly much less disgusting than clearing up others waste. The Vacuumed Refuse Pack is compact and sealed. So, odor will not escape and users will not come into contact with the waste.

During nominal use in Zero-gravity environment, the user will not come in contact with the waste material. Liquid waste such as urine, loose stool, vomit and menses will be absorbed by the SAP layer. Sticky stool will stick to the surface of the SAP layer. If it does not do that in Zero-gravity environment, a safety Net is placed to prevent hard dry stool that did not stick to the SAP layer from coming in contact with the user's buttocks during use. Once the user finishes, the Main Blower continue to pull air into the Refuse pack. This prevents any solid from escaping the toilet. During that time, the user just needs to lift the Toilet Seat, put a Cover Sheet on and close the Toilet Seat. The top of the Refuse Pack is quickly sealed off once UV LED is activated.

On the Moon, there is gravity. So solid waste will stay on top of the SAP layer. Hence, no waste should escape or come into contact with the user during nominal use in both Zero-gravity environment and on the moon.

Let us consider if there is a Toilet failure. With this design, each time a user defecates, the Refuse Pack that he/she uses is vacuumed and its waste contained. This makes those Packs that are used earlier and already vacuumed not affected by the Toilet's system failure and the crew is not exposed to waste material. This is an advantage of having a small waste pack system that is easy to change, as opposed to larger waste pack systems that can store more waste material.

In the event the Toilet fails right after the user defecate into it, the top of the Refuse Pack might not be sealed because the UV LED cannot be operated. As discussed in the earlier sections, Cover Sheet that uses Pressure Sensitive Adhesive (similar to the Adhesive behind Duct Tape, but higher grade) can be use as backup to close the top of the Refuse Pack. The Flapper valve can be released manually with a screwdriver. By now, the Refuse Pack is not vacuumed, but its contents are still isolated and the crew will not come into contact with the waste. The user can expose those packs to the vacuum of space via the airlock. In this environment, the Refuse pack will still be vacuum packed as the air inside the Refuse Pack will escape via the one-way valve.

In the event the Main Blower fails during use in Zero-gravity environment, more power can automatically be directed to the Aux blower. This forms an air curtain on top of the Refuse Pack, preventing the waste inside from moving out. The user can then quickly place a Cover Sheet with PSA adhesives on to seal the top of the Refuse Pack.

### Maintenances Requirement

Preferably, there is no need to maintain the system for a 14-day space mission beyond Vacuum packing Refuse Pack by the user once the user has made his/her deposits. The pumps and blowers used are mature technologies that should not require periodic maintenance.

This Toilet does not rely on the vacuum of space to operate. It is completely isolated from Space, with zero connections to the vacuum of Space through any pipes/valves. System failure of the Toilet will not expose crew members to vacuum.

Refuse Packs also have 1-way valve, in the event of sudden exposure to Vacuum, the 1-way valve allows excess gas inside the sealed and vacuumed Packs to escape, preventing the packs from bursting.

### Force Calculation

Based on the pressure drop analysis with several centrifugal blowers in the market and from there, it is found that it is possible to move 72 m3/hr. across a pressure drop of about 310 Pa (166+146) with a 55 watt centrifugal blower.

With the pressure drop and flow rate checked for feasibility, a force calculation was done.

This models the acceleration a ball of water/stool with a diameter of 20 mm will undergo when it gets in the flow path in Zero-gravity environment. The crotch area for an average person sitting on the Toilet Seat is calculated. With this flow area and flow rate, a flow velocity is calculated. With that, a force and subsequently acceleration was calculated for a stool/ball of water that gets in the flow path. An acceleration of 0.44 m/s\hat{ }2 is obtained and that is significant when the distance to the SAP layer is only 0.175 m

### Computational Fluid Dynamics (CFD) Modelling of Flow Path in the Refuse Pack

The flow path expected inside the Refuse Pack is illustrated in FIG. 4. This rotational flow path is expected from the asymmetrical flow from the air entering the crotch area mixing with the air from the Aux blower. This has been validated by Computational Fluid Dynamics (CFD).

### Experimental Work on the Effectiveness of Super Absorbent Polymer

It was found that 25 g of SAP material found in diapers is able to absorb about 600 g of water before being saturated with obvious flow-through. This has led to the decision to place 100 g of SAP material into each Refuse Pack. 100 g will be able to absorb about 2.4 liters of urine before it is saturated, a 2.4× safety margins over 1 liter. Because of this, it is suggested that the Refuse Pack can be used to store the urine from several urinations.

### Total Mass of the System

Highly detailed and ready to be prototyped CAD drawings have been made with final dimensions for all items such as Refuse Pack, Toilet Chassis, Roller plates, etc. and supporting items such as gasket, latches, etc. The drawings are accurate and CAD software is able to calculate volume of the items drawn. With that, mass is calculated from density of the planned materials.

### Volume Of the Refuse Pack to Ensure it Can Contain 500 g of Stool

The density of stool is found to be 1.06 g/cc. Hence 500 g of stool has a volume of 472 cc. The Volume of the Refuse Pack is 7200 cc. Hence lots of safety margins there.

### Additional Features

This Toilet does NOT need any connection to Space to operate. All the Lunar Rover/Lander needs to provide is space to bolt this to the floor and power. This eases up not only the construction of the Toilet; it speeds up the design of the Lunar Rover/Lander Itself. There is zero need to consider piping's, valves, tanks, etc and the associated risks.

The present invention may be embodied in other specific forms without departing from its essential characteristics. The described embodiments are to be considered in all respects only as illustrative and not restrictive. The scope of the invention is, therefore indicated by the appended claims rather than by the foregoing description. All changes, which come within the meaning and range of equivalency of the claims, are to be embraced within their scope.

1. A toilet system (100) for a zero-gravity or microgravity environment, comprising:
a toilet seat (101) having an opening therethrough for a user to seat;
a refuse pack (102) having a rim (107) on top side with at least one opening, and a plastic sheet (108) with a bottom plate (106) for forming a compartment at bottom;
at least one air blower (103) to direct at least one human waste or any solids to the refuse pack (102) from the opening using a flow of air;
a sealed chamber (104) having a Hatch door (105), positioned below the toilet seat (101) to accommodate the refuse pack (102),
characterized in that the bottom plate (106) having at least one fastening means to secure the Refuse pack (102) to the toilet system (100) or chamber (104); at least one Flapper valve (111) connected to a vacuum pump system to pull the air from the compartment; and at least one top plate for securing on the rim (107) to seal the Refuse pack (102), in such way that the vacuum pump system pumps out the remaining the air in compartment of the sealed Refuse pack (102) for storage and containment.

2. The toilet system (100) as claimed in claim 1, further comprising at least one auxiliary blower to blow air from one side of the toilet seat (101) to route of the air into the refuse pack (102).

3. The toilet system (100) as claimed in claim 1, wherein the refuse pack (102) further comprising at least one mesh means to block the human waste or the solids return to the opening or outside of the Refuse pack (102).

4. The toilet system (100) as claimed in claim 1, wherein the refuse pack (102) further comprising at least one Super Absorbent Polymer (SAP) layer.

5. The toilet system (100) as claimed in claim 4, wherein the SAP layer attached to the plastic sheet (108), such that the air that passes through the refuse pack (102) pass through the SAP layer.

6. The toilet system (100) as claimed in claim 4, wherein the SAP layer is Air Permeable sheet.

7. The toilet system (100) as claimed in claim 1, further comprising at least one activated charcoal pack to filter-out odour from the air exiting of the vacuum pump or the toilet system (100).

8. The toilet system (100) as claimed in claim 1, wherein the top plate having a layer of UV Activated Adhesive or Pressure Sensitive Adhesive for securing onto the rim (107) of the refuse pack (102) to seal the compartment.

9. The toilet system (100) as claimed in claim 1, further comprising at least one roller plate on the chamber (104) for sliding with a sliding means to slide out to release the rim (107) of the refuse pack (102) positioned on the chamber (104).

10. The toilet system (100) as claimed in claim 1, further comprising at least one vomit attachment having a mouth piece to mount a user mouth, a flexible hose to direct at least one liquid waste from the user, and a vomit attachment for forming a seal around the toilet seat (101).

11. The toilet system (100) as claimed in claim 1, wherein the toilet seat (101) shaped in such way that the user's buttocks form at least one closure around sides of the toilet seat (101) and form a gap at the user's crotch area to receive air.

12. The toilet system (100) as claimed in claim 1, wherein the sealed Refuse pack (102) is positioned in the chamber (104) for the user to dispose.

13. The toilet system (100) as claimed in claim 1, wherein the Hatch door (105) having seal to secure is closed to seal the chamber (104) and opened to access the chamber (104).

14. A portable toilet system (100) for use in an automobile, boat, airplane or other vehicle, comprising:
a toilet seat (101) having an opening therethrough for a user to seat;
a refuse pack (102) having a rim (107) on top side with at least one opening, and a plastic sheet (108) with a bottom plate (106) for forming a compartment at bottom;
a sealed chamber (104) having a Hatch door (105), positioned below the toilet seat (101) to accommodate the refuse pack (102),
characterized in that the bottom plate (106) having at least one fastening means to secure the Refuse pack (102) to the toilet system (100) or chamber (104); at least one Flapper valve (111) connected to a vacuum pump system to pull a flow of air from the compartment; and at least one top plate for securing on the rim (107) to seal the Refuse pack (102) having at least one human waste or any solids, in such way that the vacuum pump system pumps out the remaining the air in compartment of the sealed Refuse pack (102) for storage and containment.
